(19) United States
(12) Patent Application Publication
(10) Pub. No.: US 2026/0265098 A1
(43) Pub. Date: Sep. 10, 2026

(54) BIOREACTOR WITH MEMBRANE FILTRATION AND METHODS FOR TREATING WASTEWATER

(71) Applicant: BL Technologies, Inc., Minnetonka, MN (US)

(72) Inventors: Sylvain DONNAZ, Oakville (CA); Zamir ALAM, Burlington (CA); Zebo LONG, Oakville (CA); Qirong DONG, Ancaster (CA); Christopher SHAW, Hamilton (CA)

(21) Appl. No.: 18/881,370

(22) PCT Filed: Jul. 11, 2023
(86) PCT No.: PCT/US2023/069971

§ 371 Date: Jan. 6, 2025

Related U.S. Application Data
(60) Provisional application No. 63/389,126, filed on Jul. 14, 2022.

(51) Int. Cl. C02F 3/12; B01D 65/02; B01D 69/02; B01D 69/08; B01D 71/34; B01D 71/68; C02F 3/20; C02F 11/02; C02F 11/04

(52) U.S. Cl. CPC C02F 3/1273; B01D 65/02; B01D 69/02; B01D 69/08; B01D 71/34; B01D 71/68; C02F 3/1221; C02F 3/208; C02F 11/02; C02F 11/04; B01D 2321/04; B01D 2321/185; B01D 2325/0283; B01D 2325/20; C02F 2301/046; C02F 2301/08; C02F 2303/16

(57) ABSTRACT

The present disclosure provides a wastewater treatment system that includes at least one bioreactor tank growing a biomass therein. A nanofiltration, ultrafiltration, or microfiltration membrane is housed in the bioreactor tank. The membrane is in fluid communication with a liquid outlet to discharge a permeated-effluent. The membrane may be operated to filter a biologically-treated wastewater without substantially filtering the biomass growing in the bioreactor tank. For example, permeation through the membranes may be implemented only when the biomass is settled and the membranes are exposed to a substantially clear wastewater above the settled biomass. Alternatively, or in addition, the bioreactor tank may include a non-permeated-effluent outlet, and both non-permeated-effluent and membrane-permeated effluent may be produced simultaneously.

### RELATED APPLICATIONS

This application claims priority to, and the benefit of, U.S. Provisional Patent Application No. 63/389,126, filed Jul. 14, 2022, which is incorporated herein by reference.

### FIELD

This specification relates to a bioreactor that includes membrane filtration, and associated methods for treating wastewater.

### BACKGROUND

The following paragraphs are not an admission that anything discussed in them is prior art or part of the knowledge of persons skilled in the art.

Membrane bioreactors (MBRs) combine a membrane filtration process, such as microfiltration or ultrafiltration, with a biological wastewater treatment process. The biological treatment process uses activated sludge to aerobically oxidize organic material. MBR systems may include a submerged membrane bioreactor, where the filtration membrane is located inside the biological reactor and submerged in the biomass. Alternatively, MBR systems may include a side stream membrane bioreactor, where the filtration membrane is located outside the reactor in a filtration unit downstream from the aerobic tank.

Sequencing batch reactors (SBRs) use an activated sludge treatment process in a fill-and-aeration or fill-and-draw system to treat wastewater. The SBR process steps are achieved using a single batch reactor, and a plurality of batch reactors are used in a predetermined sequence of operations with overlapping treatment cycles. For example, variable water level SBRs implement fill-and-aeration feed and use 3-step sequence, such as: filling/aeration, followed by settling, followed by decanting/draw effluent discharge. Constant water level SBRs implement fill-and-draw feed and use 3-step sequence: such as fill-and-draw, followed by aeration, followed by settling.

U.S. Pat. No. 7,547,394 describes an apparatus and method for treating wastewater with aerobic granules. The patent teaches that, in general, granules can be grown in a sequencing batch reactor having 3 phases. In a first phase, a feed can be provided to the reactor in a generally plug flow form without air while effluent is simultaneously drawn from the reactor. This simultaneously charges the reactor with feed, removes treated effluent from a previous batch and provides a period of anaerobic digestion. In a second phase, the reactor can be aerated and mixed. The aeration rate can be cycled to provide aerobic and anoxic conditions to oxidize COD and provide nitrification and denitrificaton. In a third phase, mixing and aeration can be stopped to allow the granules to settle and allow treated effluent to rise to the top of the reactor.

### INTRODUCTION

The following introduction is intended to introduce the reader to this specification but not to define any invention. One or more inventions may reside in a combination or sub-combination of the apparatus elements or method steps described below or in other parts of this document. The inventors do not waive or disclaim their rights to any invention or inventions disclosed in this specification merely by not describing such other invention or inventions in the claims.

In one aspect, the present disclosure provides a wastewater treatment system. The system may include a sequencing batch reactor with a plurality of bioreactor tanks.

In one example, the present disclosure provides a wastewater treatment system that includes a sequencing batch reactor that includes a plurality of bioreactor tanks, each bioreactor tank growing a biomass therein, and having a liquid inlet for an influent wastewater. The system also includes a plurality of nanofiltration, ultrafiltration, or microfiltration membranes housed in the bioreactor tanks, the membranes being in fluid communication with liquid outlets to discharge a permeated-effluent. The membranes filter a biologically-treated wastewater without filtering the biomasses growing in the bioreactor tanks.

In another example, the present disclosure provides a wastewater treatment system that includes a biological treatment reactor. The biological treatment reactor includes a bioreactor tank growing a biomass in a biomass-portion the bioreactor tank, and having a liquid inlet for an influent wastewater. The biological treatment reactor also includes: a nanofiltration, ultrafiltration, or microfiltration membrane located in a filtration-portion of the bioreactor tank, the membrane being in fluid communication with a permeated-effluent outlet; and a non-permeated-effluent outlet located in the filtration-portion of the bioreactor tank.

In yet another example, the present disclosure provides a wastewater treatment system that includes: a bioreactor tank having a biomass-treatment portion and a filtration-portion; a liquid inlet for an influent wastewater stream, the liquid inlet being positioned to discharge a wastewater into the biomass-treatment portion of the bioreactor tank; a nanofiltration, ultrafiltration, or microfiltration membrane located in the filtration-portion of the bioreactor tank, the membrane being in fluid communication with a liquid outlet for a permeated-effluent discharge stream; and a biomass aerator located below the membrane and positioned to at least aerate the biomass-treatment portion of the bioreactor tank.

In another aspect, the present disclosure provides a process for treating a wastewater.

In one example, the present disclosure provides a method of treating an influent wastewater in a batch reactor that includes a bioreactor tank and a nanofiltration, ultrafiltration, or microfiltration membrane located in the bioreactor tank. The method includes: treating a substantially clear wastewater in the bioreactor tank with the nanofiltration, ultrafiltration, or microfiltration membrane to produce a permeated effluent, while simultaneously adding the influent wastewater to a sludge below the wastewater being treated by the membrane.

In another example, the present disclosure provides a method of treating an influent wastewater in a batch reactor that includes a bioreactor tank and a nanofiltration, ultrafiltration, or microfiltration membrane located in the bioreactor tank. The method includes: adding the influent wastewater to a sludge located at the bottom of the bioreactor tank; producing a permeated effluent from the nanofiltration, ultrafiltration, or microfiltration membrane, and optionally producing an overflow effluent; and aerobically treating the sludge in a process that includes simultaneous nitrification and denitrification, without simultaneously producing a permeated effluent from the nanofiltration, ultrafiltration, or microfiltration membrane.

In yet another example, the present disclosure provides a method of treating an influent wastewater in a batch reactor that includes a nanofiltration, ultrafiltration, or microfiltration membrane. The method includes adding the influent wastewater to a sludge blanket in a bioreactor tank without substantially disturbing the sludge blanket, while simultaneously withdrawing a permeated effluent from the nanofiltration, ultrafiltration, or microfiltration membrane, and optionally withdrawing an overflow effluent, to maintain a substantially constant volume. The method also includes treating the influent wastewater and the sludge under anoxic or anaerobic conditions to reduce the concentration of particulate biodegradable chemical oxygen demand (COD) in the influent wastewater; and aerobically treating the sludge in a process that includes simultaneous nitrification and denitrification and oxidation of soluble biodegradable COD, without simultaneously producing a permeated effluent from the nanofiltration, ultrafiltration, or microfiltration membrane. The method may optionally include allowing at least some solids suspended by the aerobic treatment to settle and reform the sludge blanket.

In still other examples, the present disclosure provides a wastewater treatment system and method as disclosed in U.S. Pat. No. 7,547,394, incorporated herein by reference, except that the reactor tanks include a nanofiltration, microfiltration, or ultrafiltration membranes located in an upper portion of the reactor tanks. In some examples, during operation, permeation through the membranes is only implemented when the biomass has settled and the membranes are exposed to a clarified wastewater above the settled biomass. Membrane permeation may implemented be during a feed period, when wastewater is being fed into a bed of granules. Membrane permeation may be implemented simultaneously with production of an overflow effluent.

In one example, the present disclosure provides a wastewater treatment method that includes the steps of: a) providing a set of sequencing batch reactors; and b) feeding wastewater through a bed of granules in each reactor for a feed time while simultaneously filtering a clarified wastewater located above the bed of granules through a nanofiltration, microfiltration, or ultrafiltration membrane. The feed time is part of a cycle time for each reactor, and the feed time for each reactor multiplied by the number of reactors is generally equal to the cycle time for each reactor.

In another example, the present disclosure provides a method of treating wastewater that includes: (a) feeding wastewater to a zone in a bioreactor having granules while simultaneously filtering wastewater from a clarified wastewater zone in the bioreactor through a nanofiltration, microfiltration, or ultrafiltration membrane; (b) treating wastewater under anaerobic conditions with the granules; (c) treating wastewater under aerobic conditions with the granules; (d) settling the granules; (e) withdrawing treated wastewater from the zone with the granules; (f) mixing the granules and the wastewater at least during step (c); and, (g) halting mixing the granules and the wastewater during step (d) to settle the granules.

In still another example, the present disclosure provides a method of treating wastewater that includes the steps of: a) providing a set of sequencing batch reactors; and b) feeding wastewater through a bed of granules in each reactor for a feed time, the feed time being part of a cycle time for each reactor, while simultaneously producing both (A) a nanofiltration, microfiltration, or ultrafiltration membrane effluent and (B) an overflow effluent. The feed time for each reactor multiplied by the number of reactors is generally equal to the cycle time for each reactor.

In yet another example, the present disclosure provides a method of treating wastewater. The method includes: (a) feeding wastewater to a zone having granules; (b) treating wastewater under anaerobic conditions with the granules; (c) treating wastewater under aerobic conditions with the granules; (d) settling the granules: (e) withdrawing treated wastewater from the zone with the granules; (f) mixing the granules and the wastewater at least during step (c); (g) halting mixing the granules and the wastewater during step (d) to settle the granules; and (h) simultaneously producing both (A) a nanofiltration, microfiltration, or ultrafiltration membrane effluent and (B) an overflow effluent during step (a) and optionally step (b).

### BRIEF DESCRIPTION OF THE DRAWINGS

Examples of the present disclosure will now be described, by way of example only, with reference to the attached Figures.

FIG. 1 is an illustration of a wastewater treatment system according to the present disclosure

FIG. 2 is an illustration of a wastewater treatment cycle according to the present disclosure.

### DETAILED DESCRIPTION

The present disclosure provides a wastewater treatment system that includes at least one bioreactor tank growing a biomass therein. The bioreactor tank includes a liquid inlet for an influent wastewater. A nanofiltration, ultrafiltration, or microfiltration membrane is housed in the bioreactor tank. The membrane is in fluid communication with a liquid outlet to discharge a permeated-effluent.

The membrane may be operated to filter a biologically-treated wastewater without substantially filtering the biomass growing in the bioreactor tank. For example, permeation through the membranes may be implemented only when the biomass is settled and the membranes are exposed to a substantially clear wastewater above the settled biomass. Alternatively, or in addition, the bioreactor tank may include a non-permeated-effluent outlet, and both non-permeated-effluent and membrane-permeated effluent may be produced simultaneously. Non-permeated-effluent and membrane-permeated effluent may be discharged in a combined effluent stream, or in separate effluent streams, depending on downstream use and/or regulations. For example, discharging a combined effluent stream to an environmental body may be advantageous over discharging only the non-permeated effluent because the combined effluent has a lower concentration levels due to the higher permeate quality of the membrane-permeated effluent. Discharging the effluents separately may be advantageous if the membrane-permeated effluent is used for irrigation, urban, agriculture, industry, or production of recycled potable water.

In the context of the present disclosure, the expressions “settled biomass”, “sludge”, and “sludge blanket” are used interchangeably. A settled biomass is produced from the settling of a mixed biomass within the bioreactor. During the settling phase, the mixed liquor suspended solids (MLSS) may start at a concentration in the range of 3 to 10 g of MLSS per Liter (g/L) and increase in concentration, such as to a concentration in the range of 6 to 40 g/L at the end of the settling phase. The settled sludge may further thicken from an MLSS concentration in the range of 3 to 10 g/L to a concentration in the range of 8 to 40 g/L, preferably 10 to 20 g/L.

The substantially clear wastewater above a settled biomass may be a wastewater having an MLSS concentration of less than 6 g/L, such as about 2 g/L or less, or about 1 g/L or less. In particular examples, the MLSS concentration of the substantially clear wastewater may be less than 0.1 g/L.

In some examples according to the present disclosure, membrane-permeated effluent may be produced when the settled biomass has an MLSS concentration greater than 4 g/L, such as a concentration in the range of 4 to 40 g/L or in the range of 10 to 20 g/L, or at a concentration of about 6 g/L, and the substantially clear wastewater above the settled biomass has an MLSS concentration of less than 15 g/L, such as a concentration less than 3 g/L. In a particular example, membrane-permeated effluent may be produced when the settled biomass has an MLSS concentration from 10 to 20 g/L and the substantially clear wastewater above the settled biomass has an MLSS concentration of less than 3 g/L.

The membranes may be exposed to different concentrations of substantially clear wastewater. For example, the membranes may be operated when (a) the upper third of the membranes are exposed to wastewater with an MLSS concentration of less than 0.5 g/L, (b) the middle third of the membranes are exposed to wastewater with an MLSS concentration of 0.5 to 1 g/L, and (c) the lower third of the membranes are exposed to wastewater with an MLSS concentration of 1 to 3 g/L.

The membranes may be operated at a flux of from about 20 to about 160 L/m²/hr (LMH), for example at a flux from about 50 to about 75 LMH. In exemplary systems sized to produce up to 2 million gallons per day (2 MGD) from a single bioreactor, the bioreactor tank may include a sufficient number of membrane cassettes to provide up to 16,000 m² of membrane surface area for a production at 20 LMH, and up to 2000 m² of membrane surface area for a production at 160 LMH.

The membrane may be positioned to filter from a filtration-portion of the bioreactor tank. The filtration-portion of the bioreactor tank may be in an upper portion of the tank when a settled biomass is in a lower portion of the tank. The filtration portion may be defined by the layer of substantially clear wastewater above the settled biomass. The settled biomass may define a biomass-portion of the tank.

It should be understood that reference to a “filtration-portion” and “biomass-portion” of the reactor tank is in relation to the reactor tank when the tank has a substantially settled biomass. The height of the membranes may be around 2.7 m (such as from 2.62 m to 2.74 m). The bioreactor tank may be from about 4.5 to about 8.0 meters, such as about 7.5 m, in height. The upper 30% to 60% of the bioreactor tank, such as the upper 35% to 50%, may comprise the filtration portion.

The bioreactor tank may include a liquid inlet positioned to add the influent wastewater to the settled biomass without substantially disturbing the biomass. The bioreactor tank may include a static or dynamic mixing device inline upstream of the liquid inlet to enhance mixing and homogenous distribution of the wastewater being added to the bioreactor tank. The liquid inlet may feed the bioreactor tank via a plurality of pipes that provide a substantially even distribution of influent wastewater to the bottom of the bioreactor tank, such that the settled sludge can be raised within the bioreactor without disturbing the interface between the biomass and the substantially clear wastewater. A substantially even distribution of influent wastewater may increase the exchange and contact time between the wastewater influent and the sludge bed, improving substrate uptake by microorganisms. In some examples, the liquid inlet may include a substantially even distribution of liquid apertures within a vertical portion of the bioreactor tank. In one example, a plurality of liquid apertures may be at the bottom of the bioreactor tank, and may be positioned in a substantially even distribution when viewed looking down at the bioreactor tank.

The biomass may have characteristics that help reduce circulation of settled biomass into the filtration-portion of the bioreactor tank when influent wastewater is added to the bioreactor tank. For example, the biomass may settle significantly faster than activated sludge flocs. The biomass may have a sludge volume index (mL/g) based on a settleability reading at 10 minutes (“SVI10”) that is within 10% of the SVI based on a settleability reading at 30 minutes (“SVI30”). In some examples, the biomass may have an SVI5 that is within 10% of an SVI30. The biomass may be a granular sludge or a densified sludge.

A biomass used in a system or method according to the present disclosure may have one or more of the following characteristics:
a settling velocity greater than 1.2 m/h, such as from 1.2 to 9.0 m/h, or greater than 10 m/h;
a dSVI (diluted SVI) of 100 mL/g or less, such as from 35 to 100 mL/g, for example from 50 to 80 mL/g;
from 50 to 90 wt % flocs, such as from 50 to 80 wt % flocs, preferably flocs with an average particle size of less than 200 μm, such as less than 100 μm;
from 10 to 85 wt % granules, such as from 20 to 60 wt % granules, preferably granules with an average particle size of greater than 100 μm, such as from 100 to 1000 μm, from 200 to 5000 μm, or from 200 to 500 μm.

In one particular example, a biomass according to the present disclosure has a dSVI of 45-100 mL/g; 20-60% of granules greater than 200 μm; and granules with an average particle diameter from 200 to 1000 μm, and preferably from 200 to 500 μm.

The wastewater treatment system may be operated with intermittent membrane permeation, where the membrane permeation is limited to periods of the process when the biomass is in a substantially settled state. Limiting membrane permeation to such periods results in exposure of the membrane to a lower concentration of solids (MLSS), compared to membrane permeation in a submerged membrane bioreactor or a side stream membrane bioreactor. Permeation of a lower concentration of MLSS may result in reduced variability of flux through the membrane during the permeation periods, reduced fouling, or both.

The wastewater treatment system may include a biomass aerator in the bioreactor tank. The biomass aerator may be positioned to at least aerate the biomass growing in the bioreactor tank. For example the biomass aerator may be positioned in or below the biomass-portion of the tank. The biomass aerator may be a full floor aerator. The biomass aerator may be adapted to provide sufficient oxygen for the bioreactor to have a dissolved oxygen concentration of from about 2.0 to 4.0 mg/L, such as a concentration of about 3.0 mg/L. The biomass aerator may be a fine bubble aerator, producing bubbles measuring less than 3 mm in diameter. Fine bubble aeration may provide 2% or more standard oxygen transfer efficiency (SOTE) during aeration. SOTE is a function of bioreactor depth and fine bubble aeration may provide 5.0 to 6.0%/m of water depth. In some examples, using a fine bubble aerator about 4 to 8 m below the surface of the liquid can provide from 20% to 48% SOTE.

The wastewater treatment system may include a membrane-scouring aerator, such as an aerator that captures process air from the biomass aerator and releases coarse aeration bubbles. Coarse aeration bubbles, used for membrane scouring, may have a diameter greater than 3 mm. Coarse bubble aeration may provide 3.3 to 4.0%/m of water depth. In some examples, using a membrane-scouring aerator about 2 to 4 m below the surface of the liquid can provide from about 7% to 16% SOTE. The membrane-scouring aerator may be an aerator as disclosed in WO2014077803, incorporated herein by reference, such as a LEAP™ aerator system sold by SUEZ Water Technologies & Solutions which may be used with ZeeWeed™ 500 membranes, also sold by SUEZ Water Technologies & Solutions. The membrane-scouring aerator may be positioned in the bioreactor tank so that, when the biomass is substantially settled, the membrane-scouring aerator is above the settled biomass and below the membrane. In this manner, the membrane-scouring aerator may scour the membrane without substantially disturbing the settled biomass.

The bioreactor may additionally include a waste activated sludge (WAS) outlet, or a WAS separation and recycle system. The WAS separation and recycle system may include a gravimetric selection and recycle system; or a hydrocyclone in fluid communication with a WAS outlet and a return WAS stream.

The wastewater treatment system may additionally include a pre-treatment system, a buffer tank, or both located upstream of the bioreactor tank and in fluid communication with the liquid inlet for the influent wastewater. The wastewater treatment system may additionally or alternatively include a post-treatment system located downstream of the bioreactor tank. A post-treatment system may be one or more treatment units that provide: nanofiltration, ultrafiltration, or microfiltration of a waste activated sludge effluent; reduction or removal of compounds contributing to soluble chemical oxygen demand (COD) and/or biological oxygen demand (BOD); reduction or removal of soluble phosphorous; or any combination thereof. Some systems according to the present disclosure may discharge a portion of the waste activated sludge effluent without further treatment.

The wastewater treatment system may additionally include a source of powdered activated carbon (PAC). The PAC may be added directly to the bioreactor tank, or may be added to the influent wastewater stream.

A wastewater treatment system, or a method, according to the present disclosure may use a submerged membrane. The membrane may have one or more of the following features. The membrane may be a hollow-fiber membrane. The membrane may be a non-ionic and hydrophilic membrane, such as a polyvinylidene fluoride (PVDF) or a modified polyethersulfone (PES) membrane or a ceramic membrane. The membrane may have an average pore size of about 0.1 nm to about 10 μm, such as from about 0.1 nm to about 10 nm, such as from about 0.01 μm to about 10 μm, such as from about 0.01 to about 0.1 μm, for example from about 0.02 to about 0.04 μm, or from about 0.1 to about 10 μm. The membrane may have a molecular weight cutoff (MWCO) from about 200 Da to about 750 kDa. The membrane may have a permeability of greater than 900 lmh/bar. Using a nanofiltration membrane may be particularly desirable in a system or method for micro-pollutant removal.

The membrane may be a membrane sold by Suez Water Technologies & Solution as a ZeeWeed™ submerged ultrafiltration membrane. The membrane may be a ZeeWeed 500, or ZeeWeed 1000 membrane.

A wastewater treatment system according to the present disclosure may include a plurality of bioreactors as discussed above, where the plurality of bioreactors are incorporated into a sequencing batch reactor (SBR). As SBR may be used to adapt a batch process to large continuous, possibly variable rate, feed flows. In an SBR, a number of reactors are provided in parallel and fed in sequence. Each bioreactor may be operated in a cycle that includes: a feed phase, an anaerobic or anoxic treatment phase, an aerobic treatment phase, and an optional settling phase. In the feed phase, the biomass is maintained as a substantially settled biomass. In some examples, the membrane-permeate effluent and the optional overflow effluent are produced only during the feed phase.

The feed phase and the anaerobic or anoxic treatment phase may partially or completely overlap. If the SBR uses a densified or granular sludge, the aerobic treatment phase may include simultaneous nitrification and denitrification, even without cycling the aeration rate to provide aerobic and anoxic conditions.

The present disclosure also provides a method of treating an influent wastewater in a batch reactor that includes a bioreactor tank and a nanofiltration, ultrafiltration, or microfiltration membrane located in the bioreactor tank. The methods disclosed herein may be practiced with a system or bioreactor as disclosed above, or may incorporate one or more features of the a system or bioreactor as disclosed above.

The method includes a feed phase of adding the influent wastewater to a sludge located at the bottom of the bioreactor tank, and producing a permeated effluent from the nanofiltration, ultrafiltration, or microfiltration membrane, and optionally producing an overflow effluent. The overflow effluent may be combined with the permeated effluent. In some examples, the permeated effluent may be produced from filtration of a substantially clear wastewater located above the sludge.

The influent wastewater may be added at a solids loading rate from about 8 to about 40 kgMLSS/m²/h, such as at about 8 kgMLSS/m²/h at an average daily flow (ADF) or about 15 kgMLSS/m²/h at a peak hour flow (PHF).

The method may include producing the permeated effluent while simultaneously adding the influent wastewater to the sludge. The volume of the wastewater may be kept substantially constant. Alternatively or additionally, the method may include aerobically treating the sludge in a process that includes simultaneous nitrification and denitrification, without simultaneously producing a permeated effluent from the nanofiltration, ultrafiltration, or microfiltration membrane. The aerobic treatment may include intermittent aeration of the biomass, for example to keep the biomass solids from settling but maintaining the dissolved oxygen concentration at a level that promotes anoxic conversation of nitrate to nitrogen gas.

The influent wastewater may be added to the sludge without substantially disturbing the sludge. For example, the influent wastewater may be added at an upflow velocity from about 1.0 to about 4.0 m/h, such as at about 2.5 m/h at average daily flow (ADF) or about 3.3 m/h at a peak hour flow (PHF).

It should be understood that, in the context of the present disclosure, the expression “substantially disturbing the settled biomass” refers to mixing the settled biomass in a manner that increases the MLSS concentration of the wastewater surrounding the membrane to a level of greater than 6.0 g/L. Preferably, the MLSS concentration of the wastewater surrounding the membrane is maintained at a level less than 2 g/L, such as less than 1 g/L, and more preferably less than 0.5 g/L.

Adding the influent wastewater and producing a permeated effluent may be performed through a repeated fill-and-draw cycle. A fill-and-draw cycle may include simultaneous addition of influent wastewater and production of membrane-permeated effluent. Each fill-and-draw cycle may be performed for a predetermined time period, or may be stopped at a predetermined transmembrane pressure (TMP) or fouling rate. A fill-and-draw cycle may be performed for a length of time from 15 minutes to 1 hour. A maximum allowable TMP or a maximum allowable fouling rate may be used to trigger a backwash period. The TMP limit may be a transmembrane pressure from 5 psi to 13 psi. Successive fill-and-draw cycles may be separated by a relax and/or backwash period. The relax period or the backwash period may be from about 30 seconds to about 1 minute in length. The backwash flow rate may be 30 L/m²/h (LMH) or more. The backwash may additionally include chemical cleaning.

One specific example of adding influent wastewater and producing a permeated effluent includes: (i) simultaneously adding influent wastewater and producing a permeated effluent for 30 minutes, (ii) relaxing for 30 seconds, (iii) simultaneously adding influent wastewater and producing a permeated effluent until the TMP is 10 psi, (iv) backwashing for 1 minute, and (v) simultaneously adding influent wastewater and producing a permeated effluent for 30 minutes. In this example, steps (i), (iii) and (v) correspond to three fill-and-draw cycles, and steps (ii) and (iv) correspond to relax and backwash periods.

Another specific example of adding influent wastewater and producing a permeated effluent includes: (i) producing a permeated effluent for 15 minutes, (ii) adding influent wastewater, (iii) backwashing for 30 seconds, (iv) producing a permeated effluent for 15 minutes, (v) adding influent wastewater. In this example, steps (i) and (ii) together, and steps (iv) and (v) together, each correspond to a fill-and-draw cycle.

During a fill-and-draw cycle, wastewater influent may be added in a sufficiently even distribution to the biomass-portion of the bioreactor tank to raise the biomass in a plug-flow manner, without disturbing the interface between the biomass and the substantially clear wastewater, to push the substantially clear wastewater to the bioreactor outlet and/or membranes.

A method according to the present disclosure may include membrane scouring while producing the permeated effluent, during a relax and/or backwash period, or both. The membrane scouring may include continuous or intermittent aeration. The scouring aeration gas may be provided by accumulating bubbles diffusing from the biomass and intermittently releasing scouring bubbles, or through an external gas source. The scouring aeration bubbles may be released by an aerator located below the membranes, but above the sludge. A method that includes membrane scouring may include scouring the membrane with continuous or intermittent aeration while producing the permeated effluent; scouring the membrane with continuous or intermittent aeration while adding the influent wastewater to the sludge; or both.

A method according to the present disclosure may include anoxically or anaerobically treating the sludge in a process that reduces the concentration of particulate biodegradable chemical oxygen demand (COD) in the influent wastewater. The anoxic or anaerobic treatment may maintain the biomass at a dissolved oxygen concentration of less than 0.2 mg/L, such as at a concentration of 0.0 to 0.1 mg/L. The anoxic or anaerobic treatment may maintain the biomass at an oxygen reduction potential (ORP) level of from −100 to +50 mV ENH (H₂ electrode reference) to enhance biological phosphorus removal. The anoxic or anaerobic treatment may maintain the biomass at an oxygen reduction potential (ORP) level of from +50 to +200 mV ENH (H₂ electrode reference) to enhance denitrification and reduction of nitrates (NO₃—N). The anoxic or anaerobic treatment may be maintained for a period of about 45 minutes to about 90 minutes, for example a period of about 65 minutes, before shifting to a subsequent treatment phase, such as an aerobic treatment phase. The anoxic or anaerobic treatment may produce volatile fatty acids from the biodegradeable COD. The sludge may be under the anoxic or anaerobic treatment conditions during at least some of the feed phase. Even in methods that include scouring membrane aeration, the sludge may be under the anoxic or anaerobic treatment conditions when the scouring aeration does not substantially disturb the settled biomass.

A method according to the present disclosure may include aerobically treating the sludge in a process that includes simultaneous nitrification and denitrification, and/or oxidation of soluble biodegradable COD. The aerobic treatment phase may include aeration, biomass mixing, or both. In some examples, the aerobic treatment phase results in an MLSS concentration of up to 8.0 g/L, such as from about 4.0 g/L to about 8.0 g/L in the liquid surrounding the membranes. The aerobic treatment phase may be at a dissolved oxygen concentration of from about 0.2 to 4.0 mg/L, such as at a concentration of about 3.0 mg/L. In exemplary methods according to the present disclosure, no permeated effluent is produced from the membranes during the aerobic treatment phase, such as while the bioreactor has a dissolved oxygen concentration of 2.0 mg/L or higher. In some methods, the aeration treatment phase may be from about 45 minutes to about 130 minutes in length. The level of ammonia and/or dissolved oxygen may be measured during the aeration treatment phase. The aeration treatment phase may be terminated when the ammonia level is reduced to 5.0 mg NH₄—N/L or less, such as less than 1.0 mg NH₄—N/L, when the total nitrogen (TN) is less than 10 mg/L. Soluble biodegradable COD may be fermented by the biomass to volatile fatty acids (VFAs). Phosphate accumulating organisms (PAOs) may store the VFAs as polyhydroxybutyrate (PHB) in the cells and release the intracellular polyP to the environment as PO4-P.

A method according to the present disclosure may include a settling phase. In the settling phase, solids suspended during the aerobic treatment phase are allowed to settle to reform the sludge and the substantially clear wastewater. Preferably, no permeated effluent is produced before the sludge has reformed. The settling phase may include a membrane backwash period, with optional chemical cleaning.

A portion of the sludge may be removed from the bioreactor tank. The removed sludge may be selected or treated to separate a higher density fraction from a lower density fraction.

In exemplary systems, the removed sludge may be treated in a gravimetric selection and recycle system or hydrocyclone. The gravimetric selection may apply from a force of from 10 to 20 G, as well as a shear force, to the removed sludge. The higher density fraction may be recycled to the bioreactor, such as by adding the higher density fraction to the influent wastewater. The lower density fraction may be wasted or treated in a downstream process. Exemplary gravimetric selection and recycling systems are disclosed in WO 2014/085662 A1, US 2015/0376043 A1, and EP 3978447. One example of a gravimetric selection and recycle system is an inDENSE™ system sold by NEWport GmbH, Austria. Recycling higher density fractions of sludge to the bioreactor provides a selection pressure to grow densified biomass and granules. Recycling higher density fractions of sludge may result in granules having a dSVI of from 45 to 100 mL/g, and may have a size majority from 200 to 1000 μm diameter. The sludge bed may ultimately include a single layer of granules of substantially the same size distribution. That is, the size distribution of the granules at the top of the sludge layer is substantially the same as the size distribution of the granules at the bottom of the sludge layer.

In other exemplary systems, the removed sludge may be selected from a location in the bioreactor, such as an upper portion of the sludge bed, that has a higher-than-average concentration of fine particles, pin flocs, light flocs, or any combination thereof. The sludge in an upper portion of the sludge bed corresponds to a lower density fraction of the sludge in the bioreactor. Selecting sludge from such a location can allow denser and bigger granules to be maintained in a lower portion of the sludge bed. The granules in the lower portion of the sludge bed may preferentially grow, in comparison to particles or flocs in the upper portion, due to exposure to BOD and readily biodegradable BOD (rbBOD) during feed and draw cycles. The resulting granules may have a dSVI of 50 mL/g or less, such as from 20 to 40 mL/g, and may have a size majority from 2 to 5 mm diameter. The sludge bed may ultimately include multiple layers of granules with different size distributions. That is, the size distribution of the granules in a layer at the top of the sludge is different from the size distribution of the granules in a layer at the bottom of the sludge.

A portion of the removed sludge, such as the lower density fraction of the removed sludge, may be treated in a downstream process that includes one or more of the following: ultrafiltration, microfiltration, reduction or removal of compounds contributing to soluble chemical oxygen demand (COD) and/or biological oxygen demand (BOD), reduction or removal of soluble phosphorous.

A method according to the present disclosure may additionally include a wastewater pre-treatment step, a buffering step, or both. Buffering the flow of influent wastewater, such as by adding the influent wastewater to a buffer tank and feeding the bioreactor from the buffer tank, modulates or smooths the peak influent flow rate and may reduce the total membrane area needed to treat the wastewater. A reduction in membrane area would be in comparison to an otherwise identical system without a buffer tank. Modulating or smoothing the influent flow rate may reduce the ratio of overflow effluent to membrane permeate effluent by allowing the membrane to operate at its highest permeation rate for more of the feed phase.

The biomass grown in the disclosed methods and systems may be grown under conditions that encourage growth of a granular sludge or a densified sludge, for example using a method or system as disclosed in WO2022069705, which is incorporated herein by reference. The biomass may be grown, for example, in a bioreactor that includes a plurality of sludge wasting lines between the maximum and minimum wasting levels. Sludge removed from different wasting levels, using different wasting lines, may have different densities. Recycling the higher density sludge to the reactor may provide a selection pressure to grow densified biomass and granules.

In a particular method according to the present disclosure, the method includes: adding an influent wastewater to a sludge blanket in a bioreactor tank without substantially disturbing the sludge blanket, while simultaneously withdrawing a permeated effluent from a nanofiltration, ultrafiltration, or microfiltration membrane located in the bioreactor tank, and optionally withdrawing an overflow effluent, to maintain a substantially constant volume. The method also includes treating the influent wastewater and the sludge under anoxic or anaerobic conditions to reduce the concentration of particulate biodegradable chemical oxygen demand (COD) in the influent wastewater; and aerobically treating the sludge in a process that includes simultaneous nitrification and denitrification and oxidation of soluble biodegradable COD, without simultaneously producing a permeated effluent from the nanofiltration, ultrafiltration, or microfiltration membrane. The method includes an optional settling phase where at least some solids suspended by the aerobic treatment are allowed to settle and reform the sludge blanket.

As discussed in greater detail above:
the sludge blanket may be under the anoxic or anaerobic conditions when at least some of the influent wastewater is added to the sludge blanket;
the aerobic treatment may include mixing the sludge in the sludge blanket, and optionally scouring the membrane, using an aerator located below or within the sludge blanket;
the method may include intermittent or continuous membrane scouring without substantially disturbing the sludge blanket, for example membrane scouring using an aerator located above the sludge blanket and below the membrane;
withdrawing a permeated effluent from the nanofiltration, ultrafiltration, or microfiltration membrane may include membrane filtration of a substantially clear wastewater; and/or
the method may include a plurality of fill-and-draw cycles of adding the influent wastewater while simultaneously withdrawing the permeated effluent for each cycle of aerobic treatment.

The intermittent or continuous membrane scouring may be performed during a membrane-filtration period, a period without membrane filtration, a membrane-backwash period, or any combination thereof. The intermittent or continuous membrane scouring may be performed while simultaneously adding the influent wastewater to the sludge blanket. Intermittent membrane scouring may include accumulating process gas bubbles released from the sludge blanket in a LEAP aerator, and intermittently releasing larger scouring bubbles.

Successive fill-and-draw cycles may be separated by: a backwash period, a relaxing period, a chemical cleaning period, or any combination thereof.

In another particular method according to the present disclosure, the method includes the steps of: providing a set of sequencing batch reactors; and feeding wastewater through a bed of granules in each reactor for a feed time while simultaneously: (1) filtering a clarified wastewater located above the bed of granules through a nanofiltration, microfiltration, or ultrafiltration membrane, (2) producing both a membrane effluent and an overflow effluent, or (3) both. The feed time is part of a cycle time for each reactor; and the feed time for each reactor multiplied by the number of reactors is generally equal to the cycle time for each reactor. The cycle time for a reactor may be from 2 to 10 hours, and may depend on variables such as the influent flow rate and the load scenario.

Each cycle may include treating wastewater anaerobically with the granules; and treating wastewater aerobically with the granules. The aerobic treatment may include simultaneous nitrification and denitrification.

In yet another particular method according to the present disclosure, the method includes: feeding wastewater to a zone in a bioreactor having granules while simultaneously: (1) filtering wastewater from a clarified wastewater zone in the bioreactor through a nanofiltration, microfiltration, or ultrafiltration membrane, (2) producing both a membrane effluent and an overflow effluent, or (3) both. The method also includes treating wastewater under anaerobic conditions with the granules; treating wastewater under aerobic conditions with the granules; settling the granules; withdrawing treated wastewater from the zone with the granules; mixing the granules and the wastewater at least during the treatment under aerobic conditions; and, halting mixing the granules and the wastewater during the settling step to settle the granules.

Methods and systems according to the present disclosure may be used to treat municipal wastewater, which may have the following characteristics: a COD/BOD₅ ratio from 1.8 to 3.0; a TSS/BOD₅ ratio from 0.7 to 1.2; a VSS/TSS ratio from 0.65 to 0.85; a BOD₅/TKN ratio from 3.0 to 7.0, such as from 4.0 to 5.0, for example about 5.0; a BOD/TP ratio of from 20 to 40, such as about 30; and a N—NH₄/TKN ratio from 0.6 to 0.8. The municipal wastewater may have a TSS level of 100 to 700 mg/L, such as around 300 mg/L; cBOD5 level of 100 to 700 mg/L, such as around 300 mg/L; a COD level of 200 to 1000 mg/L, such as around 650 mg/L; a TKN level of 200 to 100 mg/L, such as about 60 mg/L; a N—NH4 level of 10 to 70 mg/L, such as about 40 mg/L, and a total phosphorous level of 3 to 20 mg/L, such as about 10 mg/L.

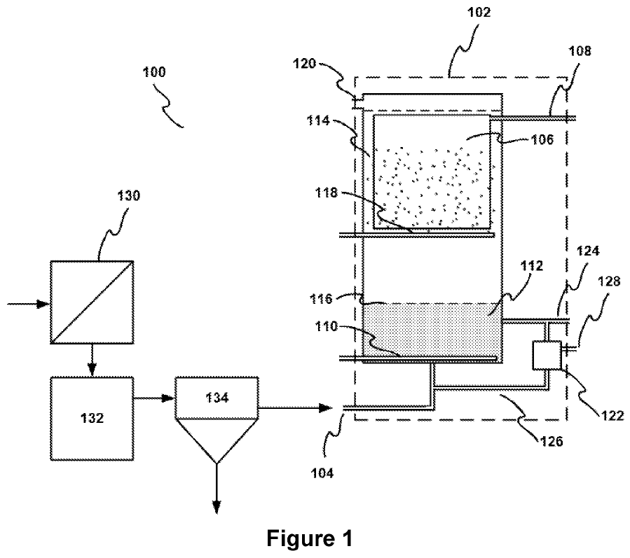

An example of wastewater system according to the present disclosure is illustrated in FIG. 1. The wastewater system (100) includes a bioreactor (102) with an influent wastewater inlet (104), a nanofiltration, microfiltration, or ultrafiltration membrane (106) located in an upper portion of the bioreactor, and a permeated-effluent outlet (108) in fluid communication with the membrane (106). The bioreactor (102) includes a biomass aerator (110) in the lower portion of the bioreactor. The bioreactor (102) is illustrated as having a settled biomass (112) in a lower portion of the bioreactor, and a substantially clear wastewater (114) surrounding the membrane (106). The settled biomass (112) and the substantially clear wastewater (114) define an interface (116). During some phases of operation, such as during an aerobic treatment phase, the biomass may be dispersed throughout the bioreactor and a settled biomass would not be present in the bioreactor.

An optional membrane-scouring aerator (118) is illustrated as being above the settled biomass (112) and below the membrane (106). In FIG. 1, the aerator (118) is illustrated as providing scouring bubbles. The bioreactor (102) is also illustrated as including an optional overflow effluent outlet (120).

The system (100) is also illustrated with an optional waste activated sludge (WAS) separation and recycle system (122). The WAS separation and recycle system (122) is in fluid communication with a WAS outlet (124) from the bioreactor, and produces a return WAS stream (126) and a WAS effluent stream (128). The WAS effluent stream (128) may be treated in a downstream phosphate removal unit, not shown, or may be discharged from the system (100) without further treatment.

The illustrated system (100) also includes an optional pre-treatment unit (130), buffer tank (132), and primary clarifying unit (134). Alternative systems may position a buffer tank downstream of a primary settling unit. The pre-treatment unit (130) may include a solids separator, such as coarse solids screen or a fine solids screen; an oil or grease separator; or any combination thereof. Wastewater, such as municipal wastewater, enters the pre-treatment unit (130). Coarse solids are removed and a permeate is transferred to the buffer tank (132), which modulates the peak influent flow rate of the incoming wastewater. The wastewater is transferred to the primary clarifying unit (134), where a primary sludge is removed and effluent is transferred to the bioreactor tank (102) via the influent wastewater inlet (104).

The system (100) may include features, or be operated under conditions, that encourage growth of a granular sludge or a densified sludge. The system (100) may, for example, include a dosing unit for adding a microorganism-carrier material (not shown), such as powdered activated carbon (PAC) particles, to the bioreactor. Adding microorganism-carrier material to the bioreactor may lead to faster granulation or densification. PAC may reduce the levels of dissolved organic or inorganic micropollutants.

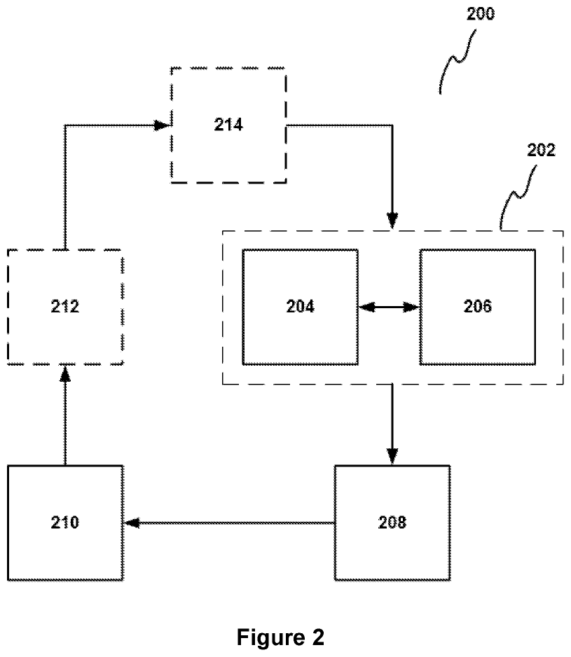

An example of a wastewater treatment cycle according to the present disclosure is illustrated in FIG. 2. The illustrated treatment cycle (200) depicts different phases of the reaction in a batch reactor, and is not a process flow diagram. The treatment cycle (200) includes a feed phase (202) wherein an influent wastewater is fed into a bioreactor that houses both a settled biomass and a nanofiltration, microfiltration, or ultrafiltration membrane with simultaneous production of a permeated effluent from the membrane. The feed phase (202) includes a plurality of fill-and-draw cycles, each fill-and-draw cycle (204) separated by a relax and/or backwash period (206).

The illustrated treatment cycle (200) also includes an anaerobic or anoxic treatment phase (208). Although the anaerobic treatment phase (208) is illustrated in FIG. 2 as subsequent to the feed phase (202), at least some portion of the two phases may occur simultaneously. For example, the influent wastewater (204) may be fed to the settled biomass while the settled biomass is in anaerobic or anoxic conditions. In the anaerobic or anoxic treatment phase (208), particulate biodegradable chemical oxygen demand (COD) in the influent is hydrolyzed to soluble biodegradable COD, which may be further consumed by the biomass microorganisms.

The illustrated treatment cycle (200) also includes an aerobic treatment phase (210) where the biomass is aerated and maintained at a dissolved oxygen concentration sufficient to promote oxidation of organic matter to carbon dioxide, oxidation of ammonia to nitrite, and oxidation of nitrite to nitrate. When the biomass is a densified biomass, the inner portion of the biomass particles remains under anoxic conditions due to the resistance of dissolved oxygen diffusion from the bulk liquid to the inner portion of a biomass particle. The anoxic portion of the biomass particle reduces the nitrate to nitrogen gas in a denitrification process. In combination, the aerobic treatment phase (210) includes simultaneous nitrification and denitrification (SND).

The illustrated treatment cycle (200) include an optional anoxic treatment phase (212) where the biomass is intermittently aerated to keep the biomass solids suspended but at a dissolved oxygen concentration that promotes anoxic conversion of leftover nitrates to nitrogen gas.

Permeated effluent is not produced during the aerobic treatment phase (210) or the anoxic treatment phase (212).

The illustrated treatment cycle (200) includes an optional settling phase (214). In the settling phase (214), the biomass is not mixed and at least some solids suspended by the aerobic treatment are allowed to settle and reform the settled biomass. The settling phase (214) illustrated in FIG. 2 includes the optional steps of separating a lower density portion of the settled biomass from a higher density portion, recycling the higher density portion back to the bioreactor, and producing a sludge effluent that includes the lower density portion. These steps are not illustrated in FIG. 2. Once the settled biomass has been reformed, the treatment cycle (200) may restart at the feed phase (202).

During periods of peaking flow into the system, the feed phase (202) may include the production of an overflow effluent (not shown) in addition to the permeated effluent. Depending on the volume of the flow into the system, the overflow effluent may make up from 0 to 99% of the total volume discharged from the bioreactor during the feed phase (202).

Treating a wastewater to a method according to the present disclosure without subsequent downstream tertiary treatment of the membrane-permeated effluent, for example without biological phosphorous removal combined with iron-coagulant polishing, may produce an effluent having: a TSS concentration of 5 mg/L or less, such as from 3 to 5 mg/L TSS or a non-detectible level of TSS; a BOD concentration of from 5 to 15 mg/L or less; a COD concentration of 50 mg/L or less; a total nitrogen concentration of from 10 to 30 mg/L; and a total phosphorous concentration of from 0.03 to 0.5 mg/L.

Preliminary designs for exemplary systems using ZeeWeed™ ultrafiltration membranes are shown in Tables 1 and 2.

TABLE 1
“Exemplary System 1” illustrates a system that removes sludge from an upper
portion of the sludge bed to support granulation, has membranes sized for 100%
permeation at peak hour flow (PHF), and that does not discharge an overflow effluent.
“Exemplary System 2” illustrates a system that uses a gravimetric selection
and recycling system to support granulation, has membranes sized for 100% permeation
at peak hour flow (PHF), and that does not discharge an overflow effluent.

| | | Exemplary | Exemplary |
|---|---|---|---|
| | | System 1 | System 2 |
| design temperature | Celsius | 12 | 12 |
| Qaverage ADF | m³/d | 28,600 | 28,600 |
| Daily Hourly flow | m³/h | 1,192 | 1,192 |
| Peak flow | m³/h | 4,200 | 4,200 |
| Hydraulic peak coefficient | — | 4 | 4 |
| TSS - influent | kg/d | 8,000 | 8,000 |
| BOD5 - influent | kg/d | 5,495 | 5,495 |
| COD - influent | kg/d | 14,636 | 14,636 |
| TN - influent | kg/d | 1,387 | 1,387 |
| NH₄—N - influent | kg/d | 1,095 | 1,095 |
| TP - influent | kg/d | 212 | 212 |
| size | PE | 91,583 | 91,583 |
| size | MLD | 29 | 29 |
| TSS - filtered effluent | mg/L | <3 | <3 |
| TN - filtered effluent | mg/L | 7 | 7 |
| NH₄—N - filtered effluent | mg/L | 1 | 1 |
| TP - filtered effluent | mg/L | 1 | 1 |
| Total biological volume | m³ | 19,200 | 26,000 |
| MLSS | g/L | 8.0 | 8.0 |
| total HRT | h | 16 | 22 |
| total SRT | days | 23 | 31 |
| F/M | kgBOD/kgVS/d | 0.05 | 0.04 |
| bioreactor depth | m | 7.5 | 7.5 |
| bioreactor footprint | m² | 2,560 | 3,467 |
| tertiary stage | — | yes | no |
| Tertiary stage volume | m³ | 1680 | — |
| Tertiary stage surface | m² | 840 | — |
| total volume | m³ | 20,880 | 26,000 |
| total footprint | m² | 3,400 | 3,467 |
| SVI design | mL/g | 40 | 60 |
| SLR limit | kg/m²/h | 30.0 | 20.0 |
| actual SLR average daily flow | kg/m²/h | 7.4 | 5.5 |
| actual SLR dry daily peak flow | kg/m²/h | 26.3 | 19.4 |
| actual SLR wet daily peak flow | kg/m²/h | 26.3 | 19.4 |
| SOR limit | m/h | 3.8 | 2.5 |
| actual SOR average daily flow | m/h | 0.9 | 0.7 |
| actual SOR dry peak flow | m/h | 3.3 | 2.4 |
| actual SOR wet peak daily flow | m/h | 3.3 | 2.4 |
| O₂ requirements - average | kgO₂/d | 7,236 | 7,236 |
| 100% fine bubble diffusion | % | 100% | 100% |
| Tt | — | 0.83 | 0.83 |
| DO | ppm | 4.0 | 3.0 |
| Td (DO, 100 m, 10.33 mWC, std | — | 0.77 | 0.86 |
| salinity level) | | | |
| Tp (ALFA) | — | 0.71 | 0.69 |
| Global transfer coefficient - average | — | 0.45 | 0.49 |
| Immersion depth | m | 7.25 | 7.25 |
| Oxgen transfer efficiency - average | % | 40% | 40% |
| Aeration consumption (bioprocess) - | Nm³/d | 134,208 | 123,646 |
| average | | | |
| cycle time | hours | 4.0 | 4.0 |
| fill and draw cycle | hours | 1.5 | 1.5 |
| total fill and draw per day | h/d | 9.0 | 9.0 |
| targeted flux at maximum PHF flow | Imh | 75 | 75 |
| targeted flux at ADF flow | Imh | 60 | 60 |
| Nb of cassette at PHF | u. | 47 | 47 |
| Nb of cassette at ADF | u. | 17 | 17 |
| Zeeweed-UF | | | |
| % inlet FLOW | % | 100% | 100% |
| Flow condition for membrane sizing | — | PHF | PHF |
| MBR surface area at ADF | m² | 19,861 | 19,861 |
| MBR surface area at PHF | m² | 149,333 | 149,333 |
| No. Cassettes (64 modules of | u. | 48 | 48 |
| 49.26 m² each) | | | |
| Imh ADF | Imh | 21 | 21 |
| Imh PHF | Imh | 74 | 74 |
| operating ADF, Imh | Imh | 60 | 60 |
| utilization factor (Imh ADF/operating | % | 35% | 35% |
| ADF Imh) | | | |

TABLE 2
“Exemplary System 3” illustrates a system that uses a gravimetric selection
and recycling system to support granulation, has membranes sized for 100% permeation
at average daily flow (ADF), and that discharges an overflow effluent at PHF.
“Exemplary System 4” illustrates a system: that uses a gravimetric selection
and recycling system to support granulation, and has membranes sized for 80%
permeation at average daily flow (ADF) and for 20% permeation at PHF.

| | | Exemplary | Exemplary |
|---|---|---|---|
| | | System 3 | System 4 |
| design temperature | Celsius | 12 | 12 |
| Qaverage ADF | m³/d | 28,600 | 28,600 |
| Daily Hourly flow | m³/h | 1,192 | 1,192 |
| Peak flow | m³/h | 4,200 | 4,200 |
| Hydraulic peak coefficient | — | 4 | 4 |
| TSS - influent | kg/d | 8,000 | 8,000 |
| BOD5 - influent | kg/d | 5,495 | 5,495 |
| COD - influent | kg/d | 14,636 | 14,636 |
| TN - influent | kg/d | 1,387 | 1,387 |
| NH₄—N - influent | kg/d | 1,095 | 1,095 |
| TP - influent | kg/d | 212 | 212 |
| size | PE | 91,583 | 91,583 |
| size | MLD | 29 | 29 |
| TSS - filtered effluent | mg/L | <1 | <1 |
| TN - filtered effluent | mg/L | 7 | 7 |
| NH₄—N - filtered effluent | mg/L | 1 | 1 |
| TP - filtered effluent | mg/L | 1 | 1 |
| TSS - overflow effluent at ADF | mg/L | — | 10 |
| TN - overflow effluent at ADF | mg/L | — | 7 |
| NH₄—N - overflow effluent at ADF | mg/L | — | 1 |
| TP - overflow effluent at ADF | mg/L | — | 1 |
| TSS - overflow effluent at PHF | mg/L | <15 | <15 |
| TN - overflow effluent at PHF | mg/L | 7 | 7 |
| NH₄—N - overflow effluent at PHF | mg/L | 1 | 1 |
| TP - overflow effluent at PHF | mg/L | 1 | 1 |
| Total biological volume | m³ | 26,000 | 26,000 |
| MLSS | g/L | 8.0 | 8.0 |
| total HRT | h | 22 | 22 |
| total SRT | days | 31 | 31 |
| F/M | kgBOD/kgVS/d | 0.04 | 0.04 |
| bioreactor depth | m | 7.5 | 7.5 |
| bioreactor footprint | m² | 3,467 | 3,467 |
| tertiary stage | — | no | no |
| Tertiary stage volume | m³ | — | — |
| Tertiary stage surface | m² | — | — |
| total volume | m³ | 26,000 | 26,000 |
| total footprint | m² | 3,467 | 3,467 |
| SVI design | mL/g | 60 | 60 |
| SLR limit | kg/m²/h | 20.0 | 20.0 |
| actual SLR average daily flow | kg/m²/h | 5.5 | 5.5 |
| actual SLR dry daily peak flow | kg/m²/h | 19.4 | 19.4 |
| actual SLR wet daily peak flow | kg/m²/h | 19.4 | 19.4 |
| SOR limit | m/h | 2.5 | 2.5 |
| actual SOR average daily flow | m/h | 0.7 | 0.7 |
| actual SOR dry peak flow | m/h | 2.4 | 2.4 |
| actual SOR wet peak daily flow | m/h | 2.4 | 2.4 |
| O₂ requirements - average | kgO₂/d | 7,236 | 7,236 |
| 100% fine bubble diffusion | % | 100% | 100% |
| Tt | — | 0.83 | 0.83 |
| DO | ppm | 3.0 | 3.0 |
| Td (DO, 100 m, 10.33 mWC, std | — | 0.86 | 0.86 |
| salinity level) | | | |
| Tp (ALFA) | — | 0.69 | 0.69 |
| Global transfer coefficient - average | — | 0.49 | 0.49 |
| Immersion depth | m | 7.25 | 7.25 |
| Oxgen transfer efficiency - average | % | 40% | 40% |
| Aeration consumption (bioprocess) - | Nm³/d | 123,646 | 123,646 |
| average | | | |
| cycle time | hours | 4.0 | 4.0 |
| fill and draw cycle | hours | 1.5 | 1.5 |
| total fill and draw per day | h/d | 9.0 | 9.0 |
| targeted flux at maximum PHF flow | Imh | 75 | 75 |
| targeted flux at ADF flow | Imh | 60 | 60 |
| Nb of cassette at PHF | u. | 47 | 47 |
| Nb of cassette at ADF | u. | 17 | 17 |
| Zeeweed-UF | | | |
| % inlet FLOW | % | 100% | 80% |
| Flow condition for membrane sizing | — | ADF | ADF |
| MBR surface area at ADF | m² | 52,963 | 42,370 |
| MBR surface area at PHF | m² | — | — |
| No. Cassettes (64 modules of | u. | 17 | 14 |
| 49.26 m² each) | | | |
| Imh ADF | Imh | 60 | 60 |
| Imh PHF | Imh | 59 | 58 |
| operating ADF, Imh | Imh | 60 | 60 |
| utilization factor (Imh ADF/operating | % | 100% | 100% |
| ADF Imh) | | | |

In the preceding description, for purposes of explanation, numerous details are set forth in order to provide a thorough understanding of the examples. However, it will be apparent to one skilled in the art that these specific details are not required. Accordingly, what has been described is merely illustrative of the application of the described examples and numerous modifications and variations are possible in light of the above teachings.

Since the above description provides examples, it will be appreciated that modifications and variations can be effected to the particular examples by those of skill in the art. Accordingly, the scope of the claims should not be limited by the particular examples set forth herein, but should be construed in a manner consistent with the specification as a whole.

1. A wastewater treatment system comprising:
a sequencing batch reactor comprising a plurality of bioreactor tanks, each bioreactor tank growing a biomass therein, and comprising a liquid inlet for an influent wastewater, and
a plurality of nanofiltration, ultrafiltration, or microfiltration membranes housed in the bioreactor tanks, the membranes in fluid communication with liquid outlets to discharge a permeated-effluent,
wherein the membranes filter a biologically-treated wastewater without filtering the biomasses growing in the bioreactor tanks.

2. The wastewater treatment system according to claim 1, wherein the membranes are located in upper portions of the bioreactor tanks, the biomasses are grown in lower portions of the bioreactor tanks, and the biomasses are not grown in the upper portions of the bioreactor tanks.

3. The wastewater treatment system according to claim 1, wherein the liquid inlets are positioned to add the influent wastewater to the biomasses without substantially disturbing the biomasses.

4. The wastewater treatment system according to claim 1,
further comprising a plurality of biomass aerators, at least one biomass aerator in each bioreactor tank and positioned to at least aerate the biomass growing in the bioreactor tank,
and optionally further comprising a plurality of membrane-scouring aerators, at least one membrane-scouring aerator in each bioreactor tank and positioned above the biomass to scour the membrane without substantially disturbing the biomass.

5. The wastewater treatment system according to claim 1, further comprising non-permeated-effluent outlets located the bioreactor tanks to discharge an overflow effluent, and optionally further comprising a combined overflow effluent and permeated-effluent stream.

6-11. (canceled)

12. A wastewater treatment system comprising:
a bioreactor tank having a biomass-treatment portion and a filtration-portion;
a liquid inlet for an influent wastewater stream, the liquid inlet positioned to discharge a wastewater into the biomass-treatment portion of the bioreactor tank;
a nanofiltration, ultrafiltration, or microfiltration membrane located in the filtration-portion of the bioreactor tank, the membrane in fluid communication with a liquid outlet for a permeated-effluent discharge stream; and
a biomass aerator located below the membrane and positioned to at least aerate the biomass-treatment portion of the bioreactor tank.

13. The wastewater treatment system according to claim 12, wherein the upper half of the bioreactor tank comprises the filtration portion.

14. The wastewater treatment system according to claim 12, wherein the liquid inlet for the influent wastewater stream includes a substantially even distribution of liquid apertures within the biomass-treatment portion of the bioreactor tank.

15. The wastewater treatment system according to claim 12, wherein
the bioreactor tank further comprises a non-permeated-effluent outlet for an overflow effluent,
and the wastewater treatment system optionally further comprises a combined effluent stream for the overflow effluent and the permeated-effluent.

16. The wastewater treatment system according to claim 12, further comprising a membrane-scouring aerator located below the membrane and above the biomass-treatment portion of the bioreactor tank.

17. The wastewater treatment system according to claim 12, wherein the bioreactor further comprises:
a waste activated sludge (WAS) outlet, or
a WAS separation and recycle system, such as: a gravimetric selection and recycle system; or a hydrocyclone in fluid communication with a WAS outlet and a return WAS stream.

18. The wastewater treatment system according to claim 12, further comprising:
a pre-treatment system, a buffer tank, or both located upstream of the bioreactor tank, in fluid communication with the liquid inlet for the influent wastewater;
a post-treatment system located downstream of the bioreactor tank;
or both.

19. The wastewater treatment system according to claim 18, wherein the post-treatment system provides:
nanofiltration, ultrafiltration, or microfiltration of a waste activated sludge effluent;
reduction or removal of compounds contributing to soluble chemical oxygen demand (COD) and/or biological oxygen demand (BOD);
reduction or removal of soluble phosphorous;
or any combination thereof.

20. The wastewater treatment system according to claim 12 any one of claims 1 to 19, wherein the membrane:
is a hollow-fiber membrane;
is a non-ionic and hydrophilic membrane, such as a polyvinylidene fluoride (PVDF) or a modified polyethersulfone (PES) membrane or a ceramic membrane;
has an average pore size of about 0.1 nm to about 10 μm, such as from about 0.1 nm to about 10 nm, such as from about 0.01 μm to about 10 μm, such as from about 0.01 to about 0.1 μm, for example from about 0.02 to about 0.04 μm, or from about 0.1 to about 10 μm;
has a permeability of greater than 900 lmh/bar;
molecular weight cutoff (MWCO) from about 200 Da to about 750 kDa;
or any combination thereof.

21-26. (canceled)

27. A method of treating an influent wastewater in a batch reactor that includes a bioreactor tank and a nanofiltration, ultrafiltration, or microfiltration membrane located in the bioreactor tank, the method comprising:
adding the influent wastewater to a sludge located at the bottom of the bioreactor tank;
producing a permeated effluent from the nanofiltration, ultrafiltration, or microfiltration membrane, and optionally producing an overflow effluent; and
aerobically treating the sludge in a process that includes simultaneous nitrification and denitrification, without simultaneously producing a permeated effluent from the nanofiltration, ultrafiltration, or microfiltration membrane.

28. The method according to claim 27, wherein the aerobic treatment is at a dissolved oxygen concentration of from about 0.2 to 4.0 mg/L, such as at a concentration of about 3.0 mg/L, and preferably wherein no permeated effluent is produced while the bioreactor has a dissolved oxygen concentration of 2.0 mg/L or higher.

29. The method according to claim 27, further comprising:
allowing suspended solids to settle to form the sludge and a substantially clear wastewater, preferably without simultaneously filtering the suspended solids and more preferably while simultaneously backwashing the membrane, wherein the sludge is below the membrane and the membrane is in a layer of the substantially clear wastewater

30. The method according to claim 27, further comprising:
anoxically or anaerobically treating the sludge in a process that reduces the concentration of particulate biodegradable chemical oxygen demand (COD) in the influent wastewater,
preferably wherein the anoxic or anaerobic treatment includes treatment with (a) a dissolved oxygen concentration of less than 0.2 mg/L, such as at a concentration of 0 to 0.1 mg/L, (b) an ORP level from −100 to +50 mV ENH, and/or (c) an ORP level from +50 to +200 mV ENH;
preferably wherein the anoxic or anaerobic treatment produces volatile fatty acids from the biodegradeable COD; preferably wherein the anoxic or anaerobic treatment includes producing the permeated effluent the optional overflow effluent, and adding the influent wastewater to the sludge.

31. The method according to claim 27, wherein the permeated effluent and the optional overflow effluent are produced simultaneous to the addition of the influent wastewater.

32. The method according to claim 27, wherein adding the influent wastewater to the sludge does not substantially disturb the biomass, for example wherein the adding comprises raising the biomass without disturbing an interface between the biomass and the wastewater above the biomass.

33-59. (canceled)
